(19) United States
(12) Patent Application Publication
(10) Pub. No.: US 2022/0335849 A1
(43) Pub. Date: Oct. 20, 2022

(54) DIGITAL VIDEO SHARING, ANALYSIS, AND AGGREGATION

(71) Applicant: ProMentor, Inc., Cuyahoga Falls, OH (US)

(72) Inventors: Stanley O'Day, Cuyahoga Falls, OH (US); Michael Clark, Cuyahoga Falls, OH (US); Russel R. Heiser, II, Cuyahoga Falls, OH (US); Robert A. Walker, Westlake, OH (US)

(73) Assignee: ProMentor, Inc., Cuyahoga Falls, OH (US)

(21) Appl. No.: 17/724,881

(22) Filed: Apr. 20, 2022

Related U.S. Application Data
(60) Provisional application No. 63/201,235, filed on Apr. 20, 2021.

(51) Int. Cl. G09B 5/06; H04L 65/1083; G09B 5/14

(52) U.S. Cl. CPC G09B 5/065; H04L 65/1086; G09B 5/14; G06F 3/0482

(57) ABSTRACT

Systems and methods are disclosed that facilitate providing a real-time training session between a mentor's communication device and a mentee's communication device, in which the mentor's communication device is granted control over the mentee's communication device in order to provide real-time instruction and video annotation. Mentee (player) data and progression over time are stored, and updatable ranked lists of mentees are generated for recruiting purposes, the wherein rankings are a function of player metrics, attributes, and progression over time. The systems and methods facilitate matching, mentor search and filter, scheduling, live chat, notifications, a rating system, and robust mentor profiles which include bios, photos, areas of expertise, and an introduction video.

### CROSS-REFERENCE TO RELATED APPLICATIONS

The present application claims the priority benefit of U.S. Provisional Patent Application Ser. No. 63/201,235, filed Apr. 20, 2021, entitled DIGITAL VIDEO SHARING, ANALYSIS, AND AGGREGATION, the disclosure of which is incorporated herein by reference.

### BACKGROUND

Conventional systems and methods for providing a mobile mentoring platform do not permit data analysis and aggregation for generating rankings and connecting mentees with mentors and recruiters. The following discloses certain improvements.

### SUMMARY

In one disclosed aspect, a system that facilitates providing a real-time training session between a mentor's communication device and a mentee's communication device, in which the mentor's communication device is granted control over the mentee's communication device in order to provide real-time instruction for and annotation, in accordance with various aspects set forth herein. The system further facilitates collecting mentee (player) data and progression over time, and generating updatable ranked lists of mentees for recruiting purposes, the wherein rankings are a function of player metrics, attributes, and progression over time.

According to another aspect, a system for real-time video sharing and annotation, comprises a mentor communication device on which is displayed a video sharing interface, the mentor device comprising a graphical user interface (GUI) and having installed thereon an application comprising computer-executable instructions configured to; initiate a video conferencing session with a mentee communication device; during the video conferencing session, take temporary control of a display screen on the mentee device; during control of the mentee device display screen: receive an input signal to start a video of the mentee, which is being shared in real time on display screens on both the mentor and mentee communication devices; receive an input signal to pause the shared video of the mentee; detect an annotation generated on the paused video of the mentee on the mentor communication display screen; and transmit to the mentee device in real time the annotation for real-time display on the paused video on the mentee communication device display screen.

One advantage resides in providing real-time mobile communication sessions between mentors and mentees.

Another advantage resides in mitigating contagion during training sessions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention may take form in various components and arrangements of components, and in various steps and arrangements of steps. The drawings are only for purposes of illustrating the preferred embodiments and are not to be construed as limiting the invention.

FIG. 1 illustrates a system that facilitates providing a real-time training session between a mentor's communication device and a mentee's communication device, in which the mentor's communication device is granted control over the mentee's communication device in order to provide real-time instruction for and annotation, in accordance with various aspects set forth herein.

FIG. 2 illustrates a method for matching mentors to mentees for online training sessions, tracking mentee progress, and generating ranked lists of mentees according to their progression for recruiting purposes.

FIG. 3 illustrates a simplified example of a video overlay representation wherein a model mechanics overlay (dashed stick figure) is overlaid on a still image (solid stick figure) of the mentee (e.g., a frame of the mentee's uploaded video), in accordance with one or more features described herein.

FIG. 4 illustrates a system architecture that facilitates providing online or mobile mentoring sessions between mentor and mentee devices, and warehousing session data and video for analysis and aggregation for recruiting purposes, in accordance with one or more features described herein.

FIG. 5 shows a screenshot of a mentor interface (e.g., a graphical user interface (GUI)), wherein a frame of the shared video has been selected (i.e., the video shared be the mentee device has been passed to the mentor after being granted temporary control of the video session between the mentor and mentee.

FIG. 6 shows a screenshot of an annotated frame of a shared video, in accordance with various aspects described herein.

FIG. 7 shows a screenshot of an annotated frame of a shared video with mentor-selected points A, B, and C, and an auto-generated angle between selected points, in accordance with various aspects set forth herein.

FIG. 8 illustrates an example of a graphical user interface (GUI) provided by the described app on the mentor's device, in accordance with one or more aspects described herein.

### DETAILED DESCRIPTION

To overcome the aforementioned problems, systems and methods are described that facilitate online and/or mobile training sessions between mentors and mentees, so that mentees can receive personalized one-on-one training with current and former professional mentors. A mentee can select a specific mentor or can opt to employ a matching algorithm that matches the mentee with a mentor who plays similar positions (e.g.; pitcher, catcher, infield, outfield, etc., in the case of baseball; goalie, defenseman, wing, center, etc., for a given sport such as hockey, soccer, lacrosse, etc., or any specific position within a given sport) attributes (e.g.: left handedness or right-handedness, pitching style such as overhand or sidearm; shooting style; injury history, etc.). The described systems and methods permit amateurs to learn the techniques and drills necessary to make it to the next level in their career, and also bring to attention the mental aspect and thought processes that facilitate in a given endeavor (sport, job, or the like).

The described systems, methods, platforms, architectures and applications (apps) facilitate matching mentees to mentors and recruiters, mentor search and filter, training session scheduling, live chat, notifications, rating and ranking systems, and robust mentor and mentee profiles which include bios, photos, areas of expertise, and an introduction video.

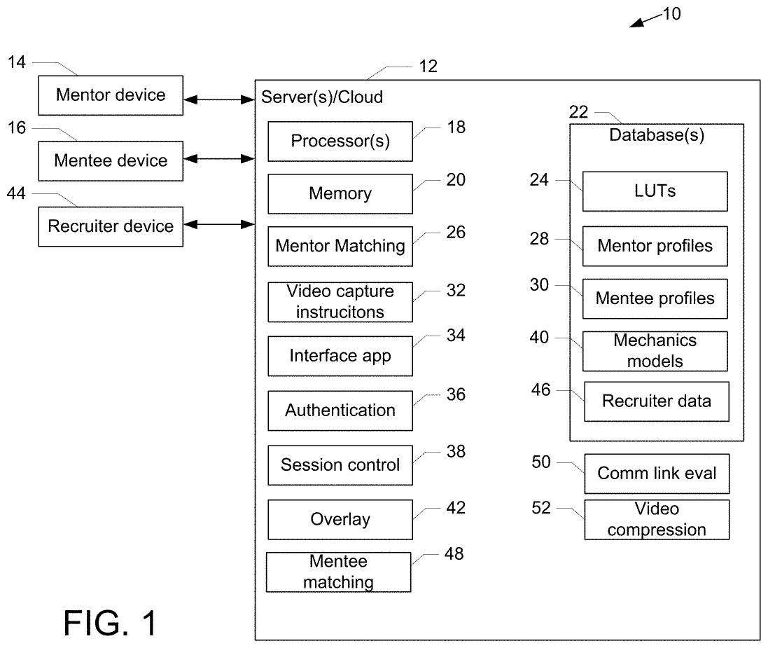

FIG. 1 illustrates a system 10 that facilitates providing a real-time training session between a mentor's communication device and a mentee's communication device, in which the mentor's communication device is granted control over the mentee's communication device in order to provide real-time instruction and annotation, in accordance with various aspects set forth herein. The system further facilitates collecting mentee (player) data and progression over time, and generating updatable ranked lists of mentees for recruiting purposes.

In one embodiment, the system comprises a server 12 via which a mentor device 14 and a mentee device 16 are connected during an online session wherein both the mentor device and the mentee device have downloaded and execute a mentoring application via which the described functionality is provided through the server. “Device” as used herein may comprise any suitable communication device (e.g., a tablet, smartphone, or any other mobile device suitable for communication via the internet, cellular, wi-fi, etc., communication means). Although FIG. 1 is described with regard to server-based functionality, it will be understood by those of skill in the art that in another embodiment, the system can be configured as a “serverless” system, i.e., cloud-based, using resources (e.g., computing resources, data storage, etc.) provided by and implemented in the Cloud. I.e., the functionality illustrated and described herein with regard to the server is provided by the Cloud. When considering the Cloud-based embodiments of the subject innovation, the description herein related to the server can be considered by substituting the word “Cloud” for the word “server.”

The server comprises one or more processors 18 that execute, and a memory 20 that stores, computer-executable instructions for performing the various acts and/or providing various functionality as described herein.

The server further comprises a database 22 that stores mentor and mentee profiles that include information (attributes, positions played, injury history, etc.) for each mentor and mentee, and one or more lookup tables (LUTs) 24 via which mentors and mentees can be matched via a mentor matching algorithm 26 that compares mentor profiles 28 and mentee profiles 30, e.g., by accessing the LUTs 24 and identifying similar profile features (e.g., attributes, position, injury history, or the like).

Once a mentor and mentee are matched by the mentor matching algorithm (or the mentee has selected a specific mentor) an online training session is scheduled. The mentee device uploads video of the mentee performing a particular movement (e.g., throwing or kicking a ball, swinging a bat, shooting a basketball, hitting a hockey puck or golf ball, etc.) In one embodiment, the mentee is provided, by the server, video capture instructions 32 for capturing the video from one or more perspectives. In a related embodiment, the mentor specifies video capture instructions that are stored in the server for the mentee. In an example where the mentee has requested help with a baseball swing, the instructions may comprise capturing video of the mentee swinging as viewed from the pitcher's mound, from behind home plate, from a specific angle (e.g., 90 degrees) relative to the batter, etc. The mentee video is stored by the server in the mentee's profile 30 and also transmitted to the mentor device. The mentor then reviews the video prior to or during the online session.

Instances of an interface application 34 are downloaded to the mentor and mentee devices prior to the online training session. At the scheduled time, the mentor and mentee use their respective devices to log into the server, through which communication during the online training session is provided. Upon log in, the mentor and mentee devices are authenticated by an authentication module 36, and the session begins. While bidirectional video chat and/or video conferencing is enabled during the training session, a session control module 38 grants temporary control of a remainder of the mentee device's screen to the mentor device, enabling the mentor to play, rewind, fast-forward, pause, etc., video of the mentee, as well as to annotate the video or the like. In one embodiment, the mentor controls the video stream that the mentee is viewing, the mentor then starts sharing the content on the mentee device's screen. This gives the mentor control of the video player and the ability to walk the mentee through the mentee's recorded video while reviewing.

In another embodiment, an annotation feature provided by the interface app running on the mentor device permits the mentor to annotate (e.g., draw on or the like) the video of the mentee. For instance, the mentor can pause the video of the mentee on a particular frame and, e.g., circle or draw an arrow highlighting a flaw in the mentee's mechanics (e.g., lack of follow through on a pitch, failure to open the hips or pulling his head during a swing, etc.). Annotation can be performed during (in real time) the training session. Annotated mentee video can then also be stored by the server in the mentee's profile 30.

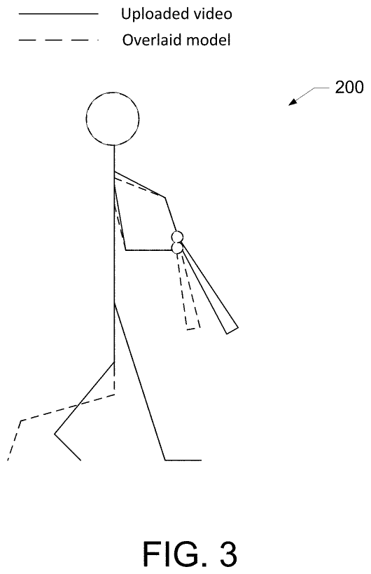

The server also comprises a database of mechanics models 40 that represent ideal mechanics for the particular motion for which the mentee is seeking training, The server includes a model overlay module 42 that provides a model mechanics overlay (see, e.g., FIG. 3) on the mentee video. The overlay may be a shadow or transparent overlay so that he mentee video is not obstructed and the mentee can see the difference between his motion and the ideal motion. The overlay can also be color coded. For instance, the overlay may be green where it aligns with the mentees body in the video, yellow where it deviates slightly, and/or red where it deviates strongly.

According to another embodiment, the model overlay is derived from a video of the mentor or other professional selected by the mentee, or matched to the mentee via the matching algorithm. For instance, if the mentee is matched with or selects a favorite player as a mentor and wants to emulate the mentor's form when pitching, swinging, kicking, swimming, etc., then the overlay will be specific to the particular mechanics of the mentor and assist the mentee in achieving that particular form.

The system 10 also comprises a recruiter device 44, via which a recruiter communicates with the server. Recruiter data 46 is stored in the database and may comprise without limitation recruiter needs (e.g., players who play a certain position and/or have certain attributes (left-handedness, certain body metrics such as height, weight, wingspan, etc., or the like).

Additionally the LUTs can be used by a mentee matching algorithm 48 to match mentee profiles to criteria specified by recruiters looking to fill a position for a team for which they are recruiting. The database and/or the mentee profiles stored therein also include information related to each mentee's progress over time. Additionally, the processor is configured to continuously and/or periodically generate and/or update a ranked list of mentees for a given sport based on the mentee's progress, achievement level(s), rate of progress, etc. In one embodiment, a recruiter (e.g., a college or pro recruiter, etc.) can log in to the server via a recruiter device 38 and can specify his particular team's need according to position (e.g., left-handed relief pitcher, goalie, blocking or receiving tight end, left wing, point guard, etc.), or other attributes (e.g., vertical jump, 40 yard dash time, 3-point shooting percentage, fastball speed, shotput distance, etc.) and be provided with a ranked or unranked list of candidates that match his team's needs.

To further this example, the recruiter can be presented with a questionnaire or fillable form provided by the server in order to facilitate searching the database. Input received by the server from the recruiter's device is parsed and a matching algorithm is executed by the processor to identify a list of matches (mentees) that are output to the recruiter's device. In one embodiment, the server outputs a ranked list of mentees that is ordered from a highest percent match to a lowest percent match.

According to yet another embodiment, the server comprises a communication link evaluation module 50 and a video compression module 52. The communication link evaluation module analyzes and evaluates communication links between the server and each device connected thereto to determine connection speed (e.g., speed tests), connection quality (e.g., SNR, BER, or any other suitable quality metric) in order to determine whether video and communication upload and download speed and quality will be affected. The compression module 52 determines and applies an appropriate amount of video compression to be applied to ensure that the video shared among devices coupled to the server is of high quality and streams smoothly. In one example the communication link evaluation module queries each user device for, e.g., its MEID or other means of identifying the device and determining the devices capability, so that a mentor on an iPhone 12 can seamlessly communicate with a mentee on e.g., an iPhone 8 or a different platform (e.g., Android, Amazon, etc.), and vice versa. User device information can be stored in the database in each respective user's profile. Based the on the device capability (e.g., capturing video in, e.g., 1080p vs. 4K) of the given device, an appropriate amount of video compression can be applied (e.g., 70% for 4K, 50% for 1080p, etc., or some other suitable amount of video compression) in order to provide a desired video quality on the less-capable device.

In another embodiment, some or all of the functionality provided by the server(s) 12 is cloud-based, in which case the cloud-based computing is leveraged to provide the herein-described systems, methods, and functions.

In another embodiment, group training sessions are provided. For instance the mentor device can be employed to initiate a video conference call, via the cloud, and a plurality of mentee devices (e.g., a youth baseball team or the like) joins the video conference call for a group training session. For mentees in the group who do not have the ProMentor app installed, a web link can be provided. When the mentee clicks on the web link, the mentee's device is directed to a sign-up page for the ProMentor service. After signing up, the mentee can join the group training session using a web-based platform (e.g., a web browser or the like).

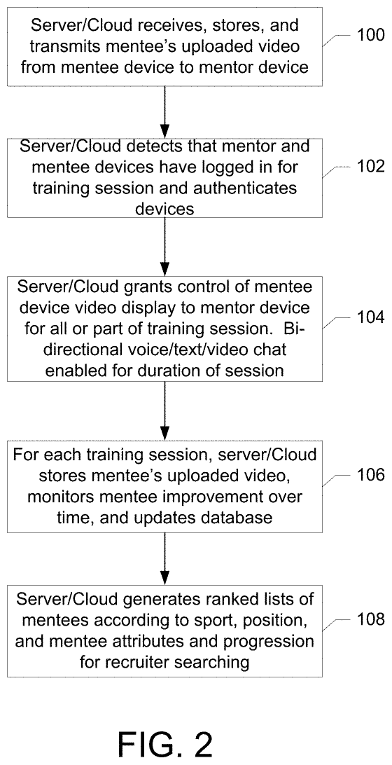

FIG. 2 illustrates a method for matching mentors to mentees for online training sessions, tracking mentee progress, and generating ranked lists of mentees according to their progression for recruiting purposes. At 100, the server receives, stores, and transmits a mentee's uploaded video to a matched mentor's device. At 102, the server detects that the mentor and mentee devices have connected to the server for a training session, and authenticates the devices. At 104, the server grants temporary control of the mentee device to the mentor device. Bi-directional communication (e.g., voice/text/video chat are enabled for the duration of the session, as well as mentor annotation capability. At 106, the server stores the mentee's uploaded video, monitors mentee improvement over time, and updates the mentee's profile in the database. At 108, the server generates and/or updates a ranked list of mentees in which the mentee is listed. Each ranked list ranks mentees according to sport, position, and mentee attributes, as well as mentee progression over time.

FIG. 3 illustrates a simplified example of a video overlay representation 200 wherein a model mechanics overlay (dashed stick figure) is overlaid on a still image (solid stick figure) of the mentee (e.g., a frame of the mentee's uploaded video), in accordance with one or more features described herein. It will be understood that the overlay is not limited to a dashed stick figure, but may a be shadow, transparency, etc., and/or may be color coded, etc. The portions of the mentee image that are misaligned with the overlay can be annotated or pointed out by the mentor. In this example, the mentee's rear foot position, bat position, and shoulder position do not conform with the model mechanics overlay.

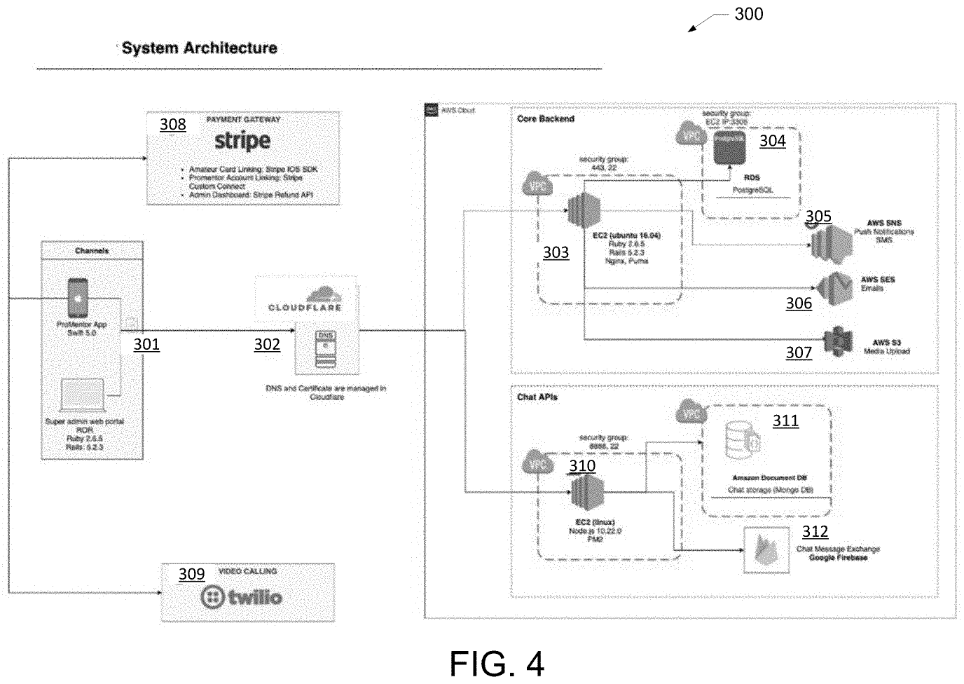

FIG. 4 illustrates a system architecture 300 that facilitates providing online or mobile mentoring sessions between mentor and mentee devices, and warehousing session data and video for analysis and aggregation for recruiting purposes, in accordance with one or more features described herein.

At 301, a user device (mentor device, mentee, device, recruiter device, etc.) logs in through the ProMentor app running on the device. A security platform 302 is provided (e.g., Cloudflare or some other suitable service), which manages DNS and certificates. Encryption (e.g., RS 2048 bit encryption or some other suitable encryption means) is provided, and passwords are hashed and stored in the database (FIG. 1) during signup. In one example, the described app uses a public key to encrypt and send information to the backend. Encrypted password information is decrypted and hashed to match the stored password for a given user.

In the core backend, which is run in the cloud (e.g., in one example, Amazon web services cloud is described, although one of skill in the art will recognize that other cloud-based services and/or platforms may be employed in conjunction with the herein described systems and/or methods), communication data is run through an operating system 303 that comprises a tech stack (e.g., Ruby, Rails, Nginx, Puma, or the like) an then on to an SQL database 304, simple notification service (SNS) 305 that provides SMS and push notification functionality, a simple email service (SES) 306 for providing email functionality, and a media upload platform 307. In one embodiment, the tech stack is a serverless infrastructure running on, e.g., GCP Functions written, e.g., Node.js and, e.g., Firestore for storage (or some other suitable storage framework. A payment gateway 308 e.g., Stripe, or some other suitable payment gateway) is also provided, via which mentor, mentee, recruiter, and service provider accounts are linked and payments are processed.

Video calling, recording, and screen sharing functionality is provided at 309. It on example, an app that uses a Web RTC technology (e.g., Twilio or the like) is integrated in the framework. A core graphics framework can be employed to draw Quadratic and Bezier curves into an image layer over a video when annotating.

Also in the cloud, chat APIs are provided. At 310, a Linux instance (by way of example only, and not limited thereto) is provided through which chat conversation data is shared, and eventually stored in a document database 311. Chat functionality is provided by a chat message exchange 312, such as Google Firebase, Amazon SNS, Azure Web PubSub, or the like, or a proprietary chat message exchange hosted by the provider of the app or website providing the described service, or some other suitable chat message exchange.

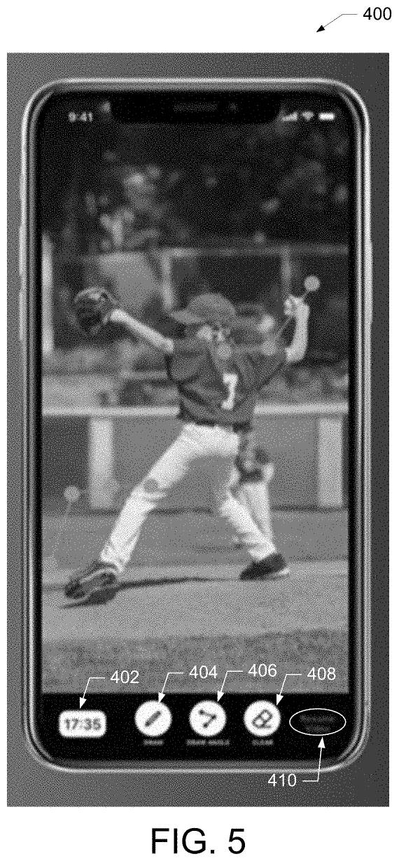

FIG. 5 shows a screenshot of a mentor interface 400 (e.g., a GUI), wherein a frame of the shared video has been selected (i.e., the video shared be the mentee device has been passed to the mentor after being granted temporary control of the video session between the mentor and mentee. See FIG. 1). The mentor interface 400 provides a plurality of selectable (and non-selectable) icons via which the mentor may manipulate and share, in real time during a live video sharing session, annotated images with the mentee. A real-time session countdown clock 402 is shown, which shows the time remaining in the video sharing session between the mentor and the mentee. This feature facilitates keeping the mentor and mentee on point during their discussion.

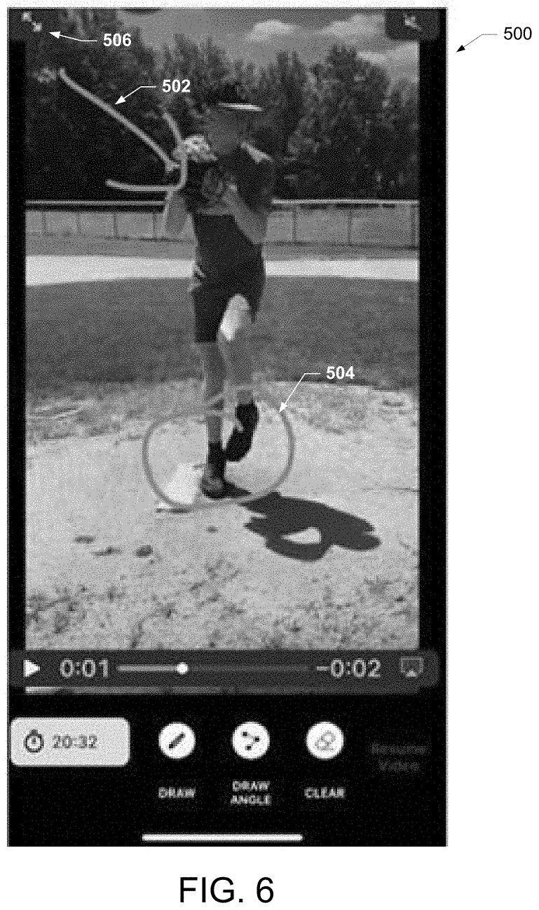

A “draw” (e.g., edit, or the like) 404 icon is illustrated, which, when selected by the mentor during control of the video session, permits the mentor to draw on the paused or selected video frame to show the mentee the aspects of the mentees form body position, etc.) that the mentor wants to discuss, highlight, etc. (See FIG. 6.)

FIG. 5 also shows an “angle” icon 406, which, when selected by the mentor, permits the mentor to select three points on the selected video frame and automatically connects the three points to show an angle of anatomical orientation in real time to the mentee.

This feature permits the mentor to show the mentee where certain body parts (feet, knees, hips, arms, shoulders, elbows, head, etc. are positioned in the mentee's form shown in the shared video, and then the mentor can explain to the mentee where the correction needs to be applied (e.g., elbow higher or lower, hips closed or opened, etc.).

A “clear” (e.g., erase, reset, etc.) icon 408 is also provided, which, when selected by the mentor during a video training session, is operable to clear all annotations from the screen. For instance, when the mentor has employed the “draw” function by selecting the draw icon and then drawing on the screen, selection of the “clear” icon resets the video frame to its original format without annotation(s).

A “resume video” icon 410 is also provided, and when selected, operates to resume the uploaded video being viewed and/or shared between the mentor and the mentee during their video session. In one embodiment, the mentor is permitted to review and annotate the uploaded video in real time with the mentee during the shared video session. In another embodiment, the mentor is permitted to review the uploaded video in advance of a shared video session. In this case, the mentor may annotate the uploaded video using the draw and/or angle icon features in advance of the shared video session and then share the annotated video with the mentee during the shared video session.

FIG. 6 shows a screenshot 500 of an annotated frame of a shared video with annotations (arrow 502) and circle 504 showing, respectively, the positions of the arm and feet of a pitcher, in accordance with various aspects described herein. The annotations are examples of those that may be provided in real time by the mentor, via the mentor's device after control over the mentee's device has been granted during the video session by the session control module 38 (FIG. 1), which may be located in a server or in the “cloud”. Also shown is a zoom icon 506, which, when clicked on allows the mentor to zoom in and out on the shared video frame. The mentor can also pinch and pull on a touch screen device to zoom in and out.

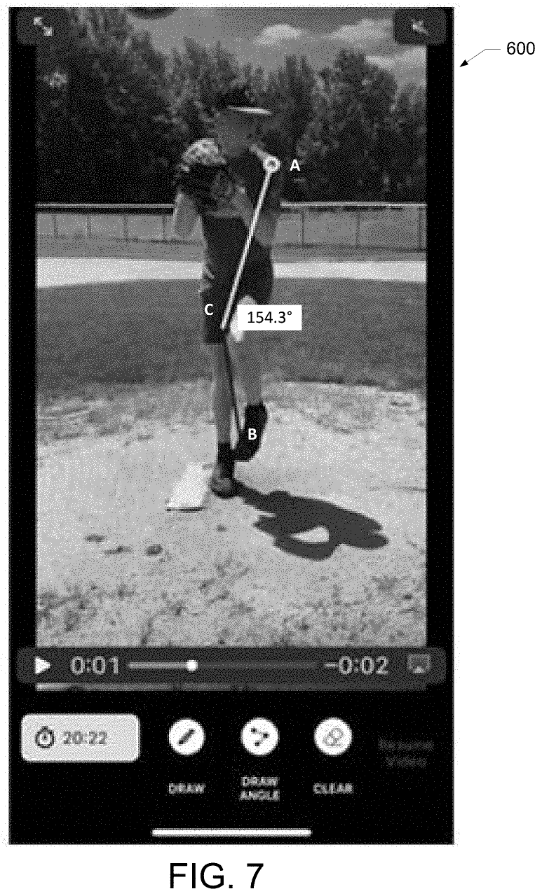

FIG. 7 shows a screenshot 600 of an annotated frame of a shared video with mentor-selected points A, B, and C, and an auto-generated (i.e., by the herein-described processors, servers, cloud-based platform(s), etc.), angle between selected points, in accordance with various aspects set forth herein. In the illustrated example, the mentor has selected the leading (left, or toward the batter, in this example) shoulder of the pitcher in the selected video frame as point “A”, and the leading foot of the pitcher as point “B”. The mentor then clicks on the pitcher's leading knee, and the processor (FIG. 1) or cloud-based resources generate visible lines (shown in yellow and blue in FIG. 7) between points A and C, and B and C. Also displayed on the mentor device interface (and the mentee device interface while the mentor device has control of the mentee device interface) during the shared video session is the angle between points A, B, and C.

The midpoint (C) between the first two selected points (A and B) is movable (i.e., the mentor can drag the midpoint) to show where the mentee's knee should be for proper form, in the case of the illustrated example).

In another embodiment, the “angle” annotation can be overlaid or combined with the “draw” annotation, e.g., to show the mentee which direction his form should be adjusted.

With continued reference to the annotation features described with regard to FIGS. 1-7, real-time video sharing and annotation is provided via the mentor communication device, on which is displayed a video sharing interface. The mentor device comprises a graphical user interface (GUI) and has installed thereon an application comprising computer-executable instructions configured to initiate a video conferencing session with a mentee communication device. During the video conferencing session, the mentor device executes instructions to take temporary control of a display screen on the mentee device. During control of the mentee device display screen the mentor device further executes instructions configured to: receive an input signal to start a video of the mentee, which is being shared in real time on display screens on both the mentor and mentee communication devices; receive an input signal to pause the shared video of the mentee; detect an annotation generated on the paused video of the mentee on the mentor communication display screen (e.g., such as when the mentor draws or writes on his device screen using a finger or stylus or the like); and transmit to the mentee device in real time the annotation for real-time display on the paused video on the mentee communication device display screen.

The instructions can further comprise receiving a signal to remove the annotations from the paused video of the mentee on both the mentor and mentee communication devices, e.g., when the mentor selects the “clear” icon to erase annotations.

In another embodiment, instructions are provided for displaying a real-time chat window on the display screens of the mentor and mentee communication devices during the video conferencing session. This feature permits the mentor and mentee(s) to discuss the annotations made by the mentor. This feature permits the mentor to draw or write on the display screen of the mentor communication device and have the drawing or writing appear on the mentee communication device(s) in real time during the shared video conferencing session.

In another embodiment, the display screen on the mentor communications device is a touch screen, and the instructions further comprise: detecting that the mentor has selected a free-form annotation option (e.g., drawing or writing on the mentor's screen); detecting touch input on the touch screen; and generating and presenting an overlaid representation of the touch input on both the display screens of the mentor and mentee communication devices in real time.

In yet another embodiment, the instructions further comprise: detecting that the mentor has selected angle annotation option; detecting touch input on the touch screen, the touch input comprising an indication of first, second, and third points selected on the paused video of the mentee e.g., the mentor selects three points on the selected video frame); and generating and presenting an overlaid representation the first, second, and third points and an angle therebetween on both the display screens of the mentor and mentee communication devices in real time. The angle overlay is generated by connecting the first and second points to the third point, which is selected last in time relative to the first and second points. By way of example, the mentor can pause the shared video of the mentee, select a “draw angle” icon on the interface on the mentor's display screen, and then select three points (e.g., shoulder, foot, and knee as shown in FIG. 7). In the example of FIG. 7, the shoulder and foot are selected before the knee, so that they are connected to show the angle between points A and B, where point C is selected last as the point of intersection between lines AC and BC. It will be noted that pints A and B may be selected in any order. In other embodiments, more than three points may be selected, with points of intersection being selected later in time than points of origin.

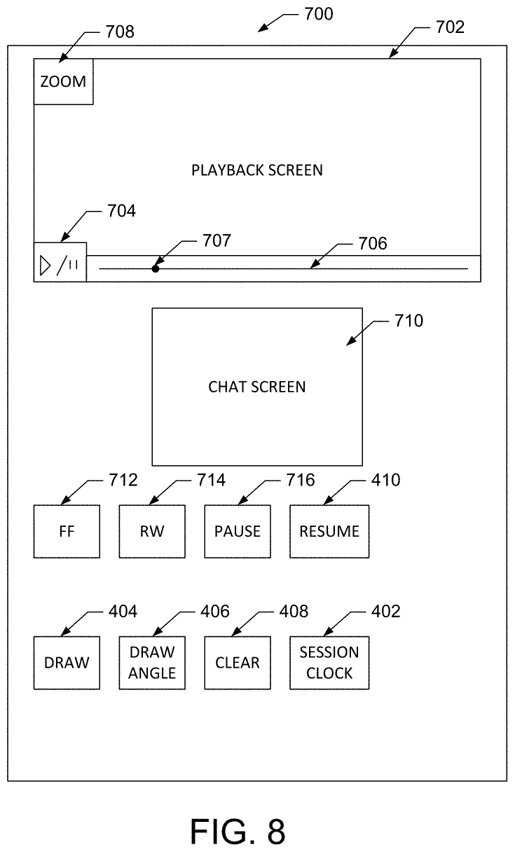

With continued reference to the preceding Figures, FIG. 8 illustrates an example of an interface 700 (e.g., a GUI) provided by the described app on the mentor's device, in accordance with one or more aspects described herein. The interface comprises a playback screen on which shared video of the mentee is presented. The playback screen includes a play/pause icon that is selectable to pause and resume the video playback. A playback progress bar 706 is also provided, and the mentor can drag a playback position indicator 707 forward or backward to fast forward or rewind the video playback. When the video is paused, the mentor can drag the indicator forward or backward to a desired video frame for annotation using the draw icon 404 and/or the draw angle icon 406. Once annotation and discussion thereof is complete, the mentor can click the “clear” icon 408 to remove the annotations and then select the resume icon 410 or the pause/play icon 704 to resume playback.

Also provided is a zoom icon 708 that permits the mentor to zoom in and out on the video or a selected frame thereof. The mentor can also zoom in and out by pinching or pulling the screen on the mentor's device using two fingers.

A chat screen 710 is provided for text chat and/or video chat during the training session and for discussion of an annotated video screen. Additionally, selectable icons for fast forward 712, rewind 714, pause 716 and resume 718 are also provided. The session clock 402 is also shown, which provides a countdown of time remaining in the training session.

With continued reference to the preceding figures, the herein-described systems and methods facilitate connecting elite (e.g., professional, semi-professional, etc.) athletes, coaches, and the like (mentors) with less elite (e.g., amateur, youth, etc.) individuals (mentees) using an interactive platform that facilitates mentoring and teaching. The described innovation facilitates live reviews of videos, where a mentor is able to highlight, annotate, etc., frames in the shared video in order to illustrate to the mentee where adjustments need to be made in order to improve the mentee's form.

The invention has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A system that facilitates capturing mentor-mentee training session data, comprising:
a cloud-based interface via which a mentor device and a mentee device communicate during a training session;
a database that stores uploaded video of the mentee; and
a session control module configured to grant to the mentor device temporary control of a mentee device screen during the training session;
wherein the mentor device comprises an interface that further comprises a plurality of selectable icons configured to, upon selection, permit the mentor to manipulate and annotate a shared video being presented on both the mentor and mentee devices.

2. The system according to claim 1, wherein the plurality of selectable icons includes a forward icon, a reverse icon, a pause icon, and a resume icon that are selectable by the mentor to control playback of the shared video on both the mentor and mentee devices in real time.

3. The system according to claim 1, wherein the plurality of selectable icons includes a “draw” icon configured to, upon selection, enable the mentor to draw annotations on a selected video frame, wherein the annotations appear in real time on the selected video frame displayed on both the mentor and mentee devices.

4. The system according to claim 1, wherein the plurality of selectable icons includes an “angle” icon configured to, upon selection, enable the mentor to generate an overlay of an angle formed by three mentor-selected points on a selected video frame, wherein the overlay is displayed in real time on the selected video frame displayed on both the mentor and mentee devices.

5. The system according to claim 4, wherein the angle overlay is automatically generated upon receiving user input, via the mentor device, comprising three points selected by the mentor on the selected video frame, and wherein first and second selected points are automatically connected to a third selected point with visible lines to illustrate an angle between the selected points.

6. The system according to claim 1, wherein the plurality of selectable icons includes a “clear” icon configured to, upon selection, removes annotations on a selected video frame.

7. The system according to claim 1, wherein the database stores a mentee profile for the mentee, the mentee profile being periodically updated to reflect mentee progress after one or more training sessions.

8. The system according to claim 1, wherein the mentor device is configured to initiate a video conference call, via the cloud, and wherein at least one mentee device joins the video conference call for the training session.

9. The system according to claim 8, wherein the mentor device is configured to initiate a video conference call, via the cloud, and wherein a plurality of mentee devices joins the video conference call for a group training session.

10. The system according to claim 9, wherein each of the plurality of mentee devices joins the video conference call for the group training session via at least one of an app and a web browser.

11. The system according to claim 1, wherein the wherein the database stores a mentee profile for each of a plurality of mentees, the mentee profile being periodically updated to reflect mentee progress after each training session.

12. The system according to claim 1, wherein the database stores a plurality of mentor profiles in a mentor profile library, the mentor profiles being searchable and selectable by one or mentees when requesting a training session.

13. A system for real-time video sharing and annotation, comprising:
a mentor communication device on which is displayed a video sharing interface, the mentor device comprising a graphical user interface (GUI) and having installed thereon an application comprising computer-executable instructions configured to;
initiate a video conferencing session with a mentee communication device;
during the video conferencing session, take temporary control of a display screen on the mentee device;
during control of the mentee device display screen:
receive an input signal to start a video of the mentee, which is being shared in real time on display screens on both the mentor and mentee communication devices;
receive an input signal to pause the shared video of the mentee;
detect an annotation generated on the paused video of the mentee on the mentor communication display screen; and
transmit to the mentee device in real time the annotation for real-time display on the paused video on the mentee communication device display screen.

14. The system according to claim 13, the instructions further comprising:
receiving a signal to remove the annotations from the paused video of the mentee on both the mentor and mentee communication devices.

15. The system according to claim 13, the instructions further comprising:
displaying a real-time chat window on the display screens of the mentor and mentee communication devices during the video conferencing session.

16. The system according to claim 13, wherein the display screen on the mentor communications device is a touch screen, the instructions further comprising:
detecting that the mentor has selected a free-form annotation option;
detecting touch input on the touch screen; and
generating and presenting an overlaid representation of the touch input on both the display screens of the mentor and mentee communication devices in real time.

17. The system according to claim 13, wherein the display screen on the mentor communications device is a touch screen, the instructions further comprising:
detecting that the mentor has selected angle annotation option;
detecting touch input on the touch screen, the touch input comprising an indication of first, second, and third points selected on the paused video of the mentee; and
generating and presenting an overlaid representation the first, second, and third points and an angle therebetween on both the display screens of the mentor and mentee communication devices in real time.

18. The system according to claim 17, the instructions further comprising generating the angle overlay by connecting the first and second points to the third point, which is selected last in time relative to the first and second points.
